(19) United States
(12) Patent Application Publication
(10) Pub. No.: US 2025/0083110 A1
(43) Pub. Date: Mar. 13, 2025

(54) MICRO-SMOOTH POROUS HYBRID MATRIX MEMBRANE STRUCTURAL SUPPORT FOR A MEMBRANE SEPARATOR

(71) Applicant: Porous Metal Filter Inc., Spring, TX (US)

(72) Inventors: Rick Kenney, Lavonia, GA (US); Rob Provo, Spring, TX (US)

(73) Assignee: Porous Metal Filter Inc., Spring, TX (US)

(21) Appl. No.: 18/826,410

(22) Filed: Sep. 6, 2024

Related U.S. Application Data
(60) Provisional application No. 63/581,033, filed on Sep. 7, 2023.

(51) Int. Cl. B01D 69/10

(52) U.S. Cl. CPC B01D 69/1071; B01D 2325/023

(57) ABSTRACT

The invention provides a porous hybrid matrix membrane support having at least one porous mesh layer of mesh densified to form a membrane mesh support and at least one porous filament layer of filaments that are generally non-woven, densified to form a membrane filament support. The filament layer is densified to provide a sufficiently small crevice depth in the membrane filament support that can help protect a membrane layer on the membrane filament support from rupturing. The membrane mesh support and the membrane filament support with micro-smooth surfaces can be integrally joined by diffusion bonding to resist separation across the adjoining surfaces. The combined, diffusion bonded support of both types of layers provide structural support sufficient for high pressures and provide substantial uniform permeability across the face of the structural support.

### CROSS REFERENCE TO RELATED APPLICATIONS

This application claims the benefit of U.S. Provisional Application No. 63/581,033, filed Sep. 7, 2023, entitled “Micro-Smooth Hybrid Porous Membrane Structural Support For A Membrane Separator” and is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to separators, such as gas separators. More specifically, the disclosure relates to porous hybrid matrix membrane structural support for a membrane separator and related method.

### Description of the Related Art

Porous membranes are becoming increasingly used for separation of compounds. Common known uses are in water treatment application, such as reverse osmosis. However, industrial processes are beginning to see the need for porous membranes to separate contaminants and molecules of compounds, including gases. As one example, hydrogen production technologies have historically relied on steam reforming of methane and lighter hydrocarbons using heat and catalysts to convert the raw hydrocarbon with steam into hydrogen with carbon dioxide and other byproducts. However, with the greenhouse gases generated, improvements are needed. With the emphasis on reduction of greenhouse gases, a porous membrane can be used in a reforming process to separate the carbon dioxide and other greenhouse gases from the hydrogen production and handle the greenhouse gases separately.

Another form of reforming is known as autothermal reforming (ATR). ATR is combination of steam reforming and partial oxidation reactions. Steam reform has been summarized above. Partial oxidation uses primarily heavy oil fractions but can also use gasified raw materials such as methane and biogas. The raw material is gasified with oxygen and possibly steam. Part of the resulting gas is burned for added heat for further processing with the target being high hydrogen yield and low carbon monoxide content.

An alternative to reforming is producing hydrogen from water electrolysis. Direct current passing through two electrodes in a water solution breaks chemical bonds in a water molecule into hydrogen and oxygen.

The above processes and others use or can use a porous membrane to separate generally gaseous constituents and other constituents in the process flow streams.

Porous membranes can be formed with several methods. Current types of technology for membrane fabrication include using fiber and felt having tortious paths. Such membranes are generally separators used at low flow and low pressure and lack substantial uniform permeability to evenly distribute flow across the flow surface. Another method is with a wet lay from a slurry of fibers to create a more uniform layer, but lacks the ability to design multiple layers of different porosity. Another method is to use mesh that provides more uniformity, but generally the pores are not small enough to separate molecules for the commercial needs described. So neither the fibers nor the mesh satisfy the need.

Attempts have been made to combine fiber and mesh. A typical supported membrane includes a porous structural support generally of metallic material as a primary support structure, and a porous separation membrane layer of metal, metal oxide, or alloys formed on the porous structural support. Methods of combining the fiber and mesh have included brazing around edges or welding that can separate from overheating, resulting in cracks and leakage. Thermal sintering is a known method but has low pore connectively and limited porosity. Diffusion bonding to a smooth surface has also been used. However, the success of the membrane depends on the underlying structural support and its bending strength in operations and uniform permeability. At higher pressures, known membrane supports and their membranes are prone to failure due at least in part to the structural support separation membrane deforming in operations with the membrane then bending into pores of the structural support and rupturing.

Therefore, there remains a need for an improved, more uniformly permeable, and effective porous membrane support for the membrane to separate compounds into components on at least a molecular level.

### BRIEF SUMMARY OF THE INVENTION

The invention provides a porous hybrid matrix membrane support having at least one porous mesh layer of mesh densified to form a membrane mesh support and at least one porous filament layer of filaments that are generally non-woven, densified to form a membrane filament support. The filament layer is densified to provide a sufficiently small crevice depth in the membrane filament support that can help protect a membrane layer on the membrane filament support from rupturing. The membrane mesh support and the membrane filament support with micro-smooth surfaces can be integrally joined by diffusion bonding to resist separation across the adjoining surfaces. The mesh of the membrane mesh support is insufficient by itself to provide a more uniform permeability for flow through the mesh and advantageously, but non-limiting, of the size needed for separation of molecular or atomic structures. The filament layer of the membrane filament support is insufficient by itself to provide structural strength to withstand the pressure drop of the flow through the membrane filament support. The combined, diffusion bonded support of both types of layers provide structural support sufficient for high pressures and provide substantial uniform permeability across the face of the structural support for the membrane layer. Advantageously, the crevice depth of the membrane filament support can be 50 μm or less, and the variability of flow permeability across the flow surface of the porous hybrid matrix membrane support can be 25 percent or less across a flow surface of the membrane support. The invention overcomes the limitations of prior porous membranes by offering a structure capable of handling higher pressures with size criteria suited for supporting a membrane layer for separating the designed components.

The invention provides a porous hybrid matrix membrane support for a membrane separator, comprising: a porous membrane mesh support of mesh; and an upstream porous membrane filament support of filaments densified to a crevice depth of 50 μm or less and diffusion bonded with the membrane mesh support to form the porous hybrid matrix membrane support having a variability of flow permeability of 25 percent or less across a flow surface of the membrane support.

The disclosure provides a method of making a porous hybrid matrix membrane support for a membrane separator, comprising: obtaining filaments; laying the filaments to form at least one layer of intermeshed filaments; densifying the layer of intermeshed filaments into a porous membrane filament support having an average crevice depth of 50 μm or less; obtaining a mesh for a membrane mesh support; and diffusion bonding the porous membrane filament support with the membrane mesh support to form the porous hybrid matrix membrane support. having a variability of flow permeability of 25 percent or less across a flow surface of the membrane support.

### BRIEF DESCRIPTION OF THE SEVERAL VIEWS OF THE DRAWINGS

FIG. 1 is a schematic cross sectional view of an illustrated filament layer of an embodiment of a membrane filament support for the porous hybrid matrix membrane support.

FIG. 2 is a schematic cross sectional view of a plurality of filament layers of another embodiment of a membrane filament support.

FIG. 3 is a schematic cross sectional view of an illustrated densified filament layer forming a membrane filament support from the filament layer of FIG. 1 or the filament layers of FIG. 2.

FIG. 4A is a schematic cross sectional view of an enlargement of the illustrated membrane filament support of FIG. 3 showing a crevice depth.

FIG. 4B is a scanning electron microscope photo of a top view of the membrane filament support of FIG. 3.

FIG. 5 is a schematic cross sectional view of an illustrated mesh layer of an embodiment of a porous hybrid matrix membrane support.

FIG. 6 is a schematic top view of a portion of the illustrated mesh layer of FIG. 5.

FIG. 7 is a schematic cross sectional view of an illustrated densified mesh layer forming a membrane mesh support from the illustrated mesh layer of FIG. 5.

FIG. 8 is a schematic top view of a portion of the illustrated membrane mesh support of FIG. 7.

FIG. 9 is a schematic cross sectional view of a plurality of mesh layers of an embodiment for a membrane mesh support of the porous hybrid matrix membrane support.

FIG. 10 is a schematic cross sectional view of an embodiment of a porous hybrid matrix membrane support.

FIG. 11 is a schematic cross sectional view of an embodiment of a separator having the porous hybrid matrix membrane support with a membrane layer.

### DETAILED DESCRIPTION

The figures described above and the written description of specific structures and functions below are not presented to limit the scope of what Applicant has invented or the scope of the appended claims. Rather, the figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The terms “top”, “up”, “upper”, “upward”, “bottom”, “down”, “lower”, “downward”, and like directional terms are used to indicate the direction relative to the figures and their illustrated orientation and are not absolute relative to a fixed datum such as the earth in commercial use. The term “inner,” “inward,” “internal” or like terms refers to a direction facing toward a center portion of an assembly or component, such as longitudinal centerline of the assembly or component, and the term “outer,” “outward,” “external” or like terms refers to a direction facing away from the center portion of an assembly or component. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Some elements are nominated by a device name for simplicity and would be understood to include a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. As such, the use of the term “exemplary” is the adjective form of the noun “example” and likewise refers to an illustrative structure, and not necessarily a preferred embodiment. Element numbers with suffix letters, such as “A”, “B”, and so forth, are to designate different elements within a group of like elements having a similar structure or function, and corresponding element numbers without the letters are to generally refer to one or more of the like elements. Any element numbers in the claims that correspond to elements disclosed in the application are illustrative and not exclusive, as several embodiments may be disclosed that use various element numbers for like elements.

The invention provides a porous hybrid matrix membrane support having at least one porous mesh layer of mesh densified to form a membrane mesh support and at least one porous filament layer of filaments that are generally non-woven, densified to form a membrane filament support. The filament layer is densified to provide a sufficiently small crevice depth in the membrane filament support that can help protect a membrane layer on the membrane filament support from rupturing. The membrane mesh support and the membrane filament support with micro-smooth surfaces can be integrally joined by diffusion bonding to resist separation across the adjoining surfaces. The combined, diffusion bonded support of both types of layers provide structural support sufficient for high pressures and provide substantial uniform permeability across the face of the structural support for the membrane layer. Advantageously, the crevice depth of the membrane filament support can be 50 μm or less, and the variability of flow permeability across the flow surface of the porous hybrid matrix membrane support can be 25 percent or less across a flow surface of the membrane support. The invention overcomes the limitations of prior porous membranes by offering a structure capable of handling higher pressures with size criteria suited for supporting a membrane layer for separating the designed components.

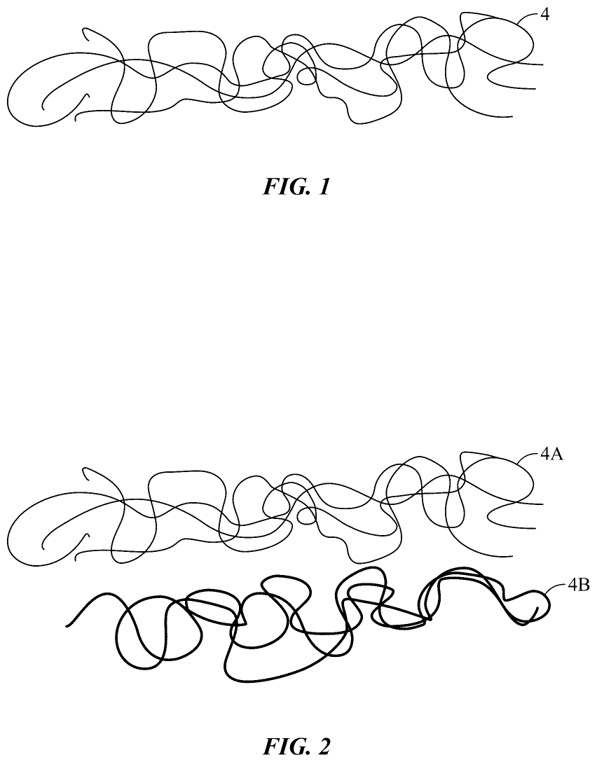

FIG. 1 is a schematic cross sectional view of an illustrated filament layer of an embodiment of a membrane filament support for the porous hybrid matrix membrane support. In making the membrane support, a quantity of filaments are provided to form a filament layer 4. The layer can be formed by air laying techniques. The filaments can be carded as well. The filaments can be of uniform filament cross-sections or a mixture of filament cross-sections. A length of the fibers can be uniform or variable and can be of a length suitable for the application that can be determined at least by routine experimentation. The filaments can be commercially available and can be formed by conventional non-woven textile technologies, including drawing, carding, calendering, spinning, or other commercially known methods. The filaments can be provided in the form of a felt, mat, or loose. The filaments can be composed of metal, metallic, polymeric, glass, ceramic, or other organic or inorganic materials, depending on the operating conditions of the application, such as temperature ranges and pressures.

FIG. 2 is a schematic cross sectional view of a plurality of filament layers of another embodiment of a membrane filament support. A plurality of filament layers, such as a first filament layer 4A and second filament layer 4B can be used to form the membrane filament support. The layers can be the same or different. Differences can include different densities, cross-sections, lengths, or material as can be appropriate for conditions in a given application.

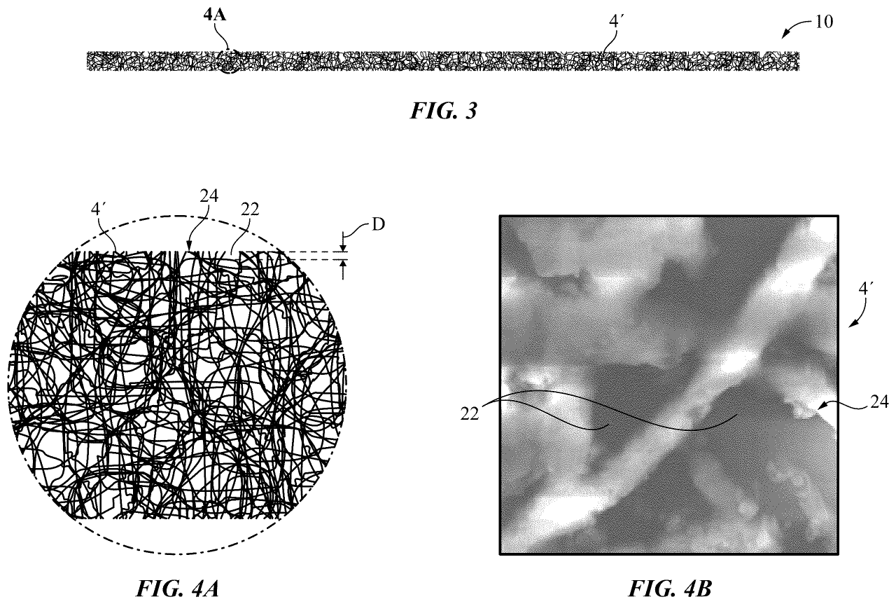

FIG. 3 is a schematic cross sectional view of an illustrated densified filament layer forming a membrane filament support from the filament layer of FIG. 1 or the layers of FIG. 2. In processing, the filament layer of FIG. 1 or layers of FIG. 2 can be densified to a compressed state and form a densified filament layer 4′ of a membrane filament support 10. The densification can be such that the filament layer 4 or plurality of layers, such as layers 4A and 4B, above, is/are transformed from recognizable filaments by human perception to a micro-smooth surface in the densified filament layer 4′ that a microscope is needed to detect a filament structure.

FIG. 4A is a schematic cross sectional view of an enlargement of the illustrated membrane filament support of FIG. 3 showing a crevice depth. The densified filament layer 4′ has crevices 22 in a supporting surface 24, where the supporting surface is generally distal from an interface between the densified filament layer 4′ and a mesh layer 6, described below. The crevices 22 are generally shallow and can help support an additional layer coupled to the supporting surface of the densified filament layer, such as a thin membrane layer of material shown in FIG. 11 below. The membrane layer, being supported in such a manner without being compromised by rupturing in a deep crevice, can have an extended life compared to a supporting surface with deep crevices and perform more consistently and with greater pressures. In at least one embodiment, a maximum average crevice depth of the densified filament layer 4′ can be 50 μm, advantageously a maximum average crevice depth of 25 μm, more advantageously a maximum average crevice depth of 15 μm, and further advantageously a maximum average crevice depth of 10 μm, and any value between, inclusively.

FIG. 4B is a scanning electron microscope photo of a top view of the membrane filament support of FIG. 3. The photo shows depths of the crevices 22 in the densified filament layer 4′. Darker shades indicate a greater crevice depth compared to surrounding crevice depths. The crevice depth even in the darker areas can have a maximum average crevice depth is 50 μm, advantageously a maximum crevice depth of 15 μm, and further advantageously a maximum crevice depth of 10 μm.

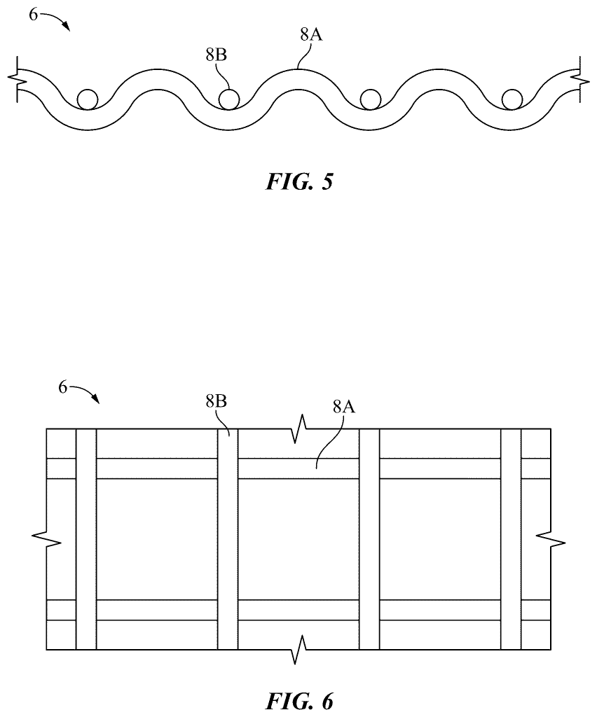

FIG. 5 is a schematic cross sectional view of an illustrated mesh layer of an embodiment of a porous hybrid matrix membrane support. FIG. 6 is a schematic top view of a portion of the illustrated mesh layer of FIG. 5. A mesh layer 6 can be of a commercial type including woven, knitted, or braided, and is formed from a plurality of wires 8A oriented in a first direction and at least another plurality of wires 8B oriented in a second direction different than the first direction of the wires 8A and are generally coupled together in some fashion. The term “wires” is used broadly herein and includes generally metallic materials of greater lengths than cross-sections. The mesh layer 6 can also be formed of a perforated plate, where the plate structure material that surrounds the perforations can be considered a series of wide “wires” crossing other “wires”. The mesh material can be composed of metal, metallic, polymeric, glass, ceramic, or other organic or inorganic materials, depending on the operating conditions of the application, such as temperature ranges and pressures.

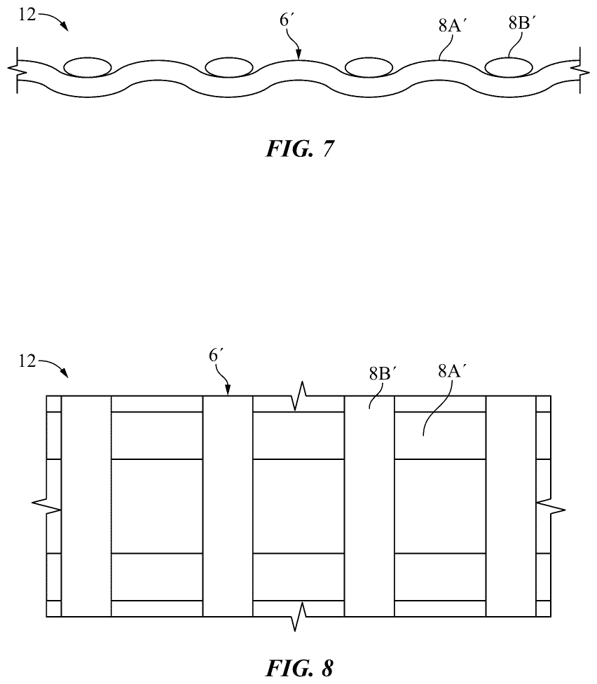

FIG. 7 is a schematic cross sectional view of an illustrated densified mesh layer forming a membrane mesh support from the illustrated mesh layer of FIG. 5. FIG. 8 is a schematic top view of a portion of the illustrated membrane mesh support of FIG. 7. The mesh layer 6 of FIGS. 5 and 6 can be densified by flattening the mesh layer 6 to form a densified mesh layer 6′ of a membrane mesh support 12. The densification can cause the wires 8A′ and 8B′ to deform as viewed in the orientation of FIG. 7 compared to FIG. 5, and FIG. 8 compared to FIG. 6. The surface of the densified mesh layer 6′ can be micro-smooth.

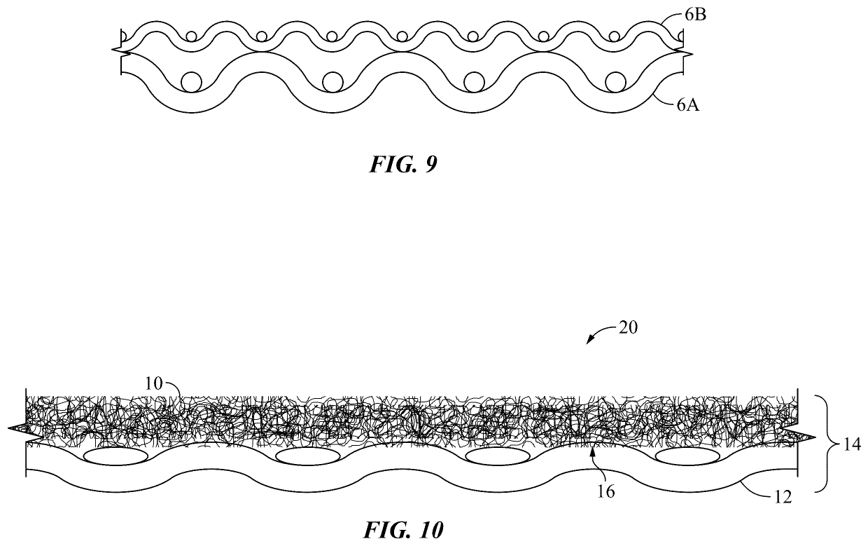

FIG. 9 is a schematic cross sectional view of a plurality of mesh layers of an embodiment of a membrane mesh support of the porous hybrid matrix membrane support. The membrane mesh support can be formed from a plurality of mesh layers 6A and 6B. The mesh layers can be the same or different. Differences can include a different mesh opening size from the crossing wires, different wire cross-sections or material, and other differences, as can be appropriate for conditions in a given application. The layers 6A and 6B can be densified to form the densified mesh layer 6′ of the membrane mesh support 12, described above.

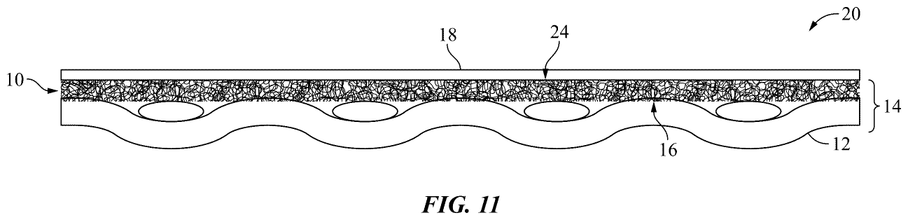

FIG. 10 is a schematic cross sectional view of an embodiment of a porous hybrid matrix membrane support. Having prepared the membrane filament support 10 and the membrane mesh support 12, the components can be coupled together to form the porous hybrid matrix membrane support 14. In at least one embodiment, the facing micro-smooth surfaces of the components can be diffusion bonded to form a diffusion zone 16 integrally joining the membrane filament support 10 and the membrane mesh support 12 to form the porous hybrid matrix membrane support 14. Appropriate pressure, temperature, time, and atmosphere as factors for the diffusion bonding process can be determined by one with ordinary skill in the art. The variability of flow permeability across the flow surface of the porous hybrid matrix membrane support 14 can be for example 25 percent or less, 15 percent or less, 8 percent or less, and any number between, inclusively, for commercial purposes. In some embodiments or applications, the porous hybrid matrix membrane support 14 can be configured with a flow permeability to separate components of a fluid and therefore function as a separator, such as a molecular separator.

FIG. 11 is a schematic cross sectional view of an embodiment of a separator having the porous hybrid matrix membrane support with a membrane layer. In some embodiments, a membrane layer 18 can be coupled with the porous hybrid matrix membrane support 14 to form a separator 20. Generally, the membrane layer 18 is coupled to the membrane mesh support 12 on the supporting surface 24, described above, due to the typical incoming flow direction toward a membrane layer on a separator. The membrane material can be composed of metal, metallic, polymeric, glass, ceramic, or other organic or inorganic materials, depending on the operating conditions of the application, such as temperature ranges and pressures. The membrane layer can be coupled to the porous hybrid matrix membrane support 14, for example, by deposition, adhesive, sintering, diffusion bonding, welding, ultrasonic coupling, and other thermal processes, and other coupling methods. The membrane layer 18 can be formed of one or more relatively smooth layers with porosity, mesh layers, filament layers, and others, alone or in combination. An example of an advantageous membrane layer for some applications could be a deposited layer of catalyst material, such a palladium, gold, silver, and others, to facilitate a particular desired separation. Other materials for a membrane layer can be appropriate for the given separation process.

Other and further embodiments utilizing one or more aspects of the inventions described above can be devised without departing from the disclosed invention as defined in the claims. For example, some of the components could be arranged in different locations, different layers, additional diffusion bonding of different layers, different shapes other than as shown, and other variations that are limited only by the scope of the claims.

The invention has been described in the context of preferred and other embodiments, and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope of the following claims.

What is claimed is:

1. A porous hybrid matrix membrane support for a membrane separator, comprising:
a porous membrane mesh support of at least one layer of mesh; and
an upstream porous membrane filament support of at least one layer of filaments densified to an average crevice depth of 50 μm or less, the membrane filament support being diffusion bonded with the membrane mesh support to form the porous hybrid matrix membrane support having a variability of flow permeability of 25 percent or less across a flow surface of the porous hybrid matrix membrane support.

2. The porous hybrid matrix membrane support of claim 1, wherein the porous membrane filament support comprises a mixture of filaments having different cross-sections.

3. The porous hybrid matrix membrane support of claim 1, wherein the porous membrane filament support comprises a first filament layer of a first filament cross-section and a second layer of a second filament cross-section that is different than the first filament cross-section.

4. The porous hybrid matrix membrane support of claim 1, wherein the membrane mesh support comprises a plurality of mesh layers.

5. The porous hybrid matrix membrane support of claim 4, wherein the plurality of mesh layers comprises layers of mesh having different mesh opening sizes.

6. The porous hybrid matrix membrane support of claim 1, wherein the porous hybrid matrix membrane support is configured with a flow permeability to separate components of a fluid.

7. A separator comprising the porous hybrid matrix membrane support of claim 1 and further comprising a membrane coupled to the porous hybrid matrix membrane support.

8. A method of making a porous hybrid matrix membrane support for a membrane separator, comprising:
obtaining filaments;
laying the filaments to form at least one layer of intermeshed filaments;
densifying the layer of intermeshed filaments into a porous membrane filament support having an average crevice depth of 50 μm or less;
obtaining a mesh for a membrane mesh support; and
diffusion bonding the membrane filament support with the membrane mesh support to form the porous hybrid matrix membrane support having a variability of flow permeability of 25 percent or less across a flow surface of the porous hybrid matrix membrane support.

9. The method of claim 8, further comprising densifying the mesh.

10. The method of claim 8, further comprising coupling a membrane to the membrane support.
